(19) United States
(12) Patent Application Publication
(10) Pub. No.: US 2004/0054812 A1
(43) Pub. Date: Mar. 18, 2004

(54) System and method for interfacing with a legacy computer system

(76) Inventors: Jiasen Liang, Scarborough (CA); Payman Hodaie, Toronto (CA)

Correspondence Address: T. ANDREW CURRIER, LANG MICHENER, 181 BAY STREET, SUITE 2500, TORONTO, ON, M5J 2T7, CA

(21) Appl. No.: 10/242,734

(22) Filed: Sep. 13, 2002

(51) Int. Cl. G06F 15/16

(52) U.S. Cl. 709/250

(57) ABSTRACT

A novel system and method for interfacing with legacy systems is provided. An enterprise server or host server hosts a front-end interface to a user. The front-end interface is operable to obtain information from the user that is otherwise required to operate the legacy systems. After collecting the information from the user, the enterprise server can then interface with one or more legacy systems, thereby accessing the functionality of the legacy system(s) thereby obviating the need to replace the legacy system with an updated system customized to the enterprise server. A method for recovering a system that interfaces with a legacy system is also provided.

### FIELD OF THE INVENTION

The present invention relates generally to computing applications executing over computer networks and more particularly relates to an apparatus and method for providing an interface to a legacy computer system.

### BACKGROUND OF THE INVENTION

The Internet, and computer networking in general, has greatly matured in the last few years. A significant area of development and growth has been electronic commerce (“e-commerce”) software, and on-line e-commerce has become an important means for conducting business.

An important component to successful e-commerce is a reliable and secure on-line payment software. Thanks to the development of on-line payment software, consumers can now reliably and securely pay for their on-line actions using credit cards, debit cards or other electronic payment means.

Those of skill in the art appreciate that the development of such on-line payment software has been painstaking and complex. For example, such on-line payment software must be reliable in that it should reconcile and coordinate events with the customer's bank and with events at the customer's on-line vendor; i.e. The on-line payment software should ensure that the correct amount was deducted from the customer's account at the customer's bank, and correspondingly ensure that the appropriate product or service is delivered to the customer.

Another important component to successful e-commerce is delivery software for managing the actual delivery of the ordered product from the on-line vendor to the customer. Such delivery software is thus coupled to the on-line payment software, each component coordinating with the other to ensure payment is received and the delivery is made. For example, where the customer has ordered a physical product, such as a book or a CD-ROM, then once the on-line payment software has processed the customer's payment, the on-line payment software can then send the order information to the vendor's delivery software, at which point the delivery software can be used to ensure that the ordered product can be pulled from the warehouse and delivered to the customer. In another example, where the customer has ordered a software product that is to be downloaded, then the delivery software ensures that appropriate network connections are set up between the on-line vendor's computers and the customer's computer, and verifies that the download actually occurred.

Where a single on-line vendor is involved, the integration of the vendor's on-line payment system and the vendor's delivery software is often handled through customization of the vendor's overall e-commerce software package. However, should the vendor wish to add other components to its e-commerce software package, it can be tedious and awkward to integrate the new component to the existing package. For example, where a vendor has an existing on-line payment system and download delivery software, but that vendor wishes to add delivery software for handling the delivery of physical products, then the integration of the added component to the legacy e-commerce software package can pose significant challenges. In particular, such integration of the new delivery system with the existing e-commerce software package must maintain the reliability and security of the customer's on-line payment.

### SUMMARY OF THE INVENTION

In a first aspect of the invention there is provided a system for interfacing with at least one legacy system. The system comprises at least one host server that is for connecting to a client computing device. The host server is for executing a software interface that is for receiving a client request from a user at the client computing device. The software interface is also for delivering responses to the client. The host server is also able to execute a legacy software application that a predefined set of user inputs. The legacy software application is for performing a first task based on the inputs. The software interface of the host server is customized to provide at least a portion of the inputs to the legacy software application based on information that is derived from the client request.

As used herein, the term “legacy software application” and the like refers to any preexisting software application that has a predefined interface (or the like) for receiving information and outputting information (or the like).

The host server is additionally for executing an additional software application. The additional software application is for performing a second task based on information that is also derived from the client request. The second task is performed in cooperation with the first task.

The host server additionally keeps an action record in an action log that is respective to the client request. The action log is for reconciling the performance of the first and second tasks (and any additional tasks) upon an initialization of the at least one host server, if the tasks should happen to be interrupted prior to actually completing the tasks.

In a particular implementation of the first aspect, the host server is a vendor server, the legacy software application is a legacy on-line payment software application and the first task is the processing of an on-line payment.

In a particular implementation of the first aspect the additional software application is a delivery system and the second task is a delivery of a requested product to a customer using the client and the cooperation is an operation based on determining whether the on-line payment can be successfully processed prior to managing the delivery. The delivery can be performed by an on-line download of software to the client, or through physically delivering the product to the customer using the client.

Where the first aspect is implemented using the above-described on-line payment and delivery software applications, then when the system is reinitialized and the action log indicates that the payment has been processed but the product has not been delivered, then the legacy software application is instructed to reverse the on-line payment. Such “reversal” can be accomplished by either not instructing the legacy software application to “complete” payment of a pre-approved action, or to instruct the legacy software application to credit the customer's account for the same amount that had been previously debited.

In a particular implementation of the first aspect involving on-line payment and corresponding delivery, when the system is reinitialized and the action log indicates that the payment has been pre-approved but the product has not been delivered, then the second software application is instructed to commence the delivery.

In a particular implementation of the first aspect, the additional software application is a second legacy software application having a predefined second set of user inputs and for performing the second task based on information derived at least in part from the second set inputs and in cooperation with the first task.

In a particular implementation of the first aspect, the legacy software application is a user authentication system.

In a particular implementation of the first aspect, the at least one host server includes a first server, a second server and a third server interconnected by a local area network, and wherein the software interface, the legacy software application and the additional software application are executed on each of the servers respectively.

In a second aspect of the invention, there is provided a method of interfacing with a legacy software application comprising the steps of:

receiving a user request;

opening an action record specific to the user request, the action record containing information for recovering a performance of the user request upon an interruption thereof;

commencing a legacy action based on information derived from the user request, the legacy action being performed by a legacy software application;

performing a second action based on information derived from the user request and a successful commencement of the legacy action;

completing the legacy action upon a successful performance of the second action;

closing the action log upon a failure of the commencement of the legacy action or a successful performance of the second action; and,

presenting an output to the user conveying information of the failure or the success.

In a particular implementation of the second aspect, the user request is a request from a customer for a product and includes payment information. The legacy action and on-line payment is performed by a legacy on-line payment software application. The commencement of the legacy action includes obtaining approval of the payment from a financial institution specified by the customer. The second action can be any action associated with an on-line payment, such as the delivery of a requested product (either through download or through physical delivery) to the customer upon a successful approval of the payment.

In a particular implementation of the second aspect, the delivery is performed by an on-line download of software to the client.

In a particular implementation of the second aspect, the approval is a pre-approval and the completing step is an instruction to the legacy software application to debit the customer's account.

In a particular implementation of the second aspect, the approval is an actual debiting of the customer's account the complete step is either:

an update of the action log to validate the debiting on successful performance of the second action; or,

an instruction to the the legacy software application to reverse the debiting (i.e. crediting the customer's account) on an unsuccessful performance of the second action.

In a particular implementation of the second aspect, the second action is a second legacy action performed by a second legacy software application.

In a particular implementation of the second aspect, the legacy software application is a user authentication system.

In a third aspect of the invention, there is provided a method of recovering a set of actions wherein at least one of the actions includes a task performed by a legacy software application comprising the steps of:

receiving a record in a log generated during an attempt to perform the actions, the log representing the status of performance of the actions; and,

determining, based on the record, whether one of the actions was performed when a second one of the actions should also have been performed and the second one of the actions not having been performed; and,

either recommencing performance of one or more of the actions so as to reconcile the actions or generating an exception report usable to reconcile the actions.

In a particular implementation of the third aspect, one of the actions includes an on-line payment performed by the legacy software application.

In a particular implementation of the third aspect, a second one of the actions includes delivery software for delivering a requested product to a customer based on a successful completion of an on-line payment, and the reconciliation includes ensuring that the product was delivered if the on-line payment was successfully performed.

### BRIEF DESCRIPTION OF THE DRAWINGS

The present invention will now be explained, by way of example only, with reference to certain embodiments and the attached Figures in which:

FIG. 1 shows a system diagram that includes an apparatus for interfacing with a legacy computer system;

FIG. 2 shows a method of interfacing with a legacy system in accordance with an embodiment of the invention;

FIG. 3 shows a method for initiating or recovering an interrupted system for interfacing with a legacy system, in accordance with an embodiment of the invention;

FIG. 4 shows a method of interfacing with a legacy system in accordance with another embodiment of the invention; and,

FIG. 5 shows a method for initiating or recovering an interrupted system for interfacing with a legacy system, in accordance with another embodiment of the invention.

### DETAILED DESCRIPTION OF THE INVENTION

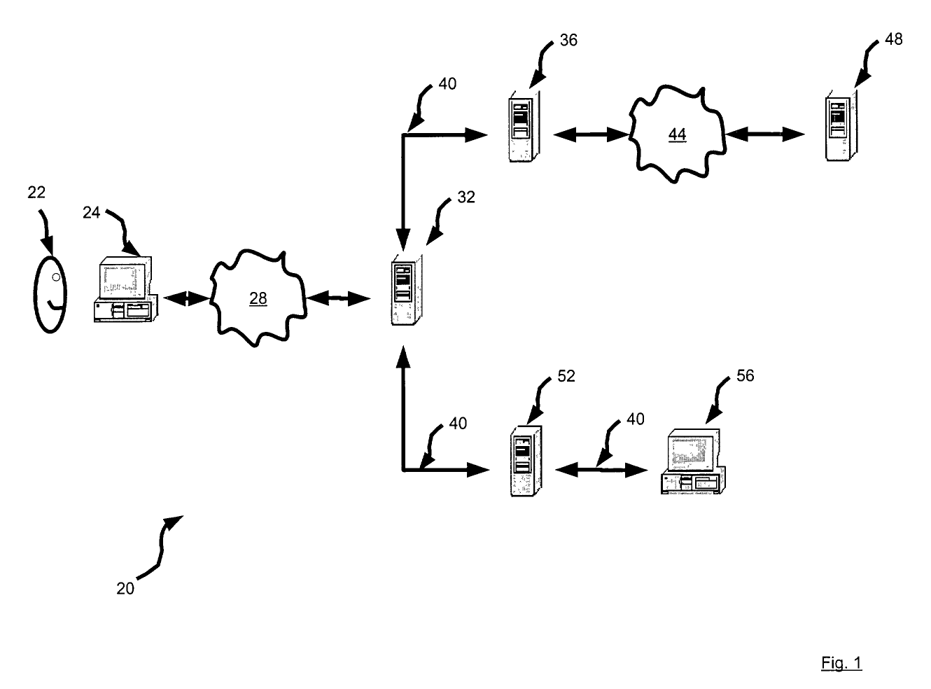

Referring now to FIG. 1, a system for interfacing with a legacy system is indicated generally at 20. System 20 comprises a client 24 that is operable to connect over a network 28 to a vendor server 32. Client 24 is thus used by a customer 22 to make on-line purchases, while vendor server 32 is used by an on-line vendor to provide a enterprise application to customer 22 accessing client 24.

In a present embodiment, client 24 is a personal computer complete with keyboard, CPU, monitor, hard disc drive and network interface card. It is to be understood, however, that client 24 can be any computing device such as a PDA, cell-phone, lap-top computer or the like that is operable to connect over network 28. Client 24 is thus operable to receive input from a customer using client 24 that wishes to access an on-line vendor. Client 24 is also operable to present data, via a monitor or other output device, to customer 22, where that outputted data represents information received from the on-line vendor via network 28.

In a present embodiment, network 28 is the Internet, however, any network communication medium for interconnecting client 24 with vendor server 32 can be used. In a present embodiment, vendor server 32 is a Sun Enterprise 10440 Server, sold by Sun Microsystems of Palo Alto, Calif., but other types of servers can be used. Vendor server 32 is thus operable to host an application, such as a web-site or the like, for client 24 via network 28. Vendor server 32 is thus generally operable to offer an enterprise application over network 28 to customer 22 accessing client 24. In the present embodiment, the enterprise application is an e-commerce application, which offers books (or other products) for sale over network 28 to customer 22 accessing client 24.

In a present embodiment, the enterprise application creates an action log when customer 22 using client 24 requests to purchase a product. The action log can be represented as a table containing a number of fields, wherein each field in the table is permanently changed during appropriate steps of the purchasing process, so that should the purchase fail part-way through, the status of the action at the time of the failure can be ascertained from the action log, and thereby facilitate the recovery of the action so that all aspects of the action are reconciled. Such permanent changes can be effected in any way that allows the recovery of the contents of the action log upon reinitialization of server 32, as those contents existed at the time of the failure. One suitable way to effect such recover is to write the contents of the table to hard disk immediately once the change in status of the action occurs.

Table 1 shows a number of exemplary data fields that can be used in an action log created by the enterprise application executing on vendor server 32.

TABLE 1
Action Log Data Fields on Vendor Server 32

| FIELD | |
|---|---|
| NUMBER | FIELD |
| 1 | Reference |
| 2 | Customer Name |
| 3 | Financial Institution |
| 4 | Account Number |
| 5 | Payment Amount |
| 6 | Payment Status |
| 7 | Product |
| 8 | Delivery Status |
| 9 | Customer Address |
| 10 | Order status |

The “Reference” field in Table 1 is a unique number or other identifier for the particular action being conducted by vendor server 32 once a request has been received from customer 22. The Reference identifier is thus typically generated once a particular customer request has been received.

The “Customer Name” field in Table 1 is the name of customer 22 accessing system 20, as provided by customer 22 at client 24.

The “Financial Institution” field in Table 1 is any identifier that can be used by payment server 36 to identify customer 22's financial institution server 48 on network 44, as provided by customer 22 at client 24.

The “Account Number” field in Table 1 is the customer 22's account number at the financial institution respective to financial institution server 48, as provided by customer 22 at client 24.

The “Payment Amount” field in Table 1 is the amount of the money to be debited from customer 22's account at the financial institution respective to financial institution server 48. The Payment Amount will typically include the purchase price of the product, and can also include other applicable charges, such as taxes, shipping and the like.

In a present embodiment, the “Payment status” field in Table 1 has three possible states—“No”, “Pre-approved” and “Complete”. This field initially set to “No” when a request from customer 22 is received to indicate that a payment has neither been pre-approved by the financial institution, nor has the actual payment been “completed”. The field is set to “Pre-approved” once the financial institution has “Pre-approved” customer 22's payment request, and is set to “Complete” to actually indicate and reflect that customer 22's account is to be debited. Further details on the “Payment Status” field will be explained in greater detail below.

The “Product” field in Table 1 reflects the specific product ordered or requested by customer 22, and typically bears a purchase price equivalent to, or contributing to, the Payment Amount.

The “Delivery Status” field in Table 1 is initially set to “False” or “No” when a request from customer 22 is received, and is used to indicated to server 32 whether or not the product ordered by customer 22 has actually been delivered.

The “Customer Address” field in Table 1 is the address of customer 22 accessing system 20.

The “Order status” field in Table 1 is initially set to “Open” when a request from customer 22 is received, and is used to indicated to server 32 whether or not the entire order with the vendor and customer 22 is “open” or “closed”.

Vendor server 32 is locally connected to a payment server 36 via a local area network 40. Payment server 36 executes a legacy on-line payment software application. Payment server can also be a Sun Enterprise 10440 Server or any other server operable to execute the legacy on-line payment software application. Example of legacy on-line payment software applications that are representative of the kind of legacy on-line payment software that can be used, when the the present embodiment is suitably configured, include Cybersource (See www.cybersource.com) or Cybercash (See www.verisign.com).

Payment server 36 is thus generally operable, using the legacy software executing thereon, to receive a customer's banking information from client 24 through network 28, server 32 and network 40. (The details of how server 32 transfers this information from client 24 to server 36 will be discussed in greater detail below.) The received banking information can then be used by payment server 36 to access a financial institution server 48 via a wide area network 44. Payment server 36 can thus work cooperatively with financial institution server 48 to deduct the appropriate amounts from the bank account (or credit card, or other credit instrument) of customer 22.

Table 2 shows a number of column headings reflecting exemplary payment information data fields that are part of legacy software application executing on payment server 36.

TABLE 2
Payment Information Data Fields on
Legacy Software Application on Payment Server 36

| FIELD | |
|---|---|
| NUMBER | FIELD |
| 1 | Reference |
| 2 | Customer Name |
| 3 | Financial Institution |
| 4 | Account Number |
| 5 | Payment Amount |
| 6 | Payment Status |

Each of the fields shown in Table 2 are typically directly available for entry and modification to a customer that would be directly accessing payment server 36 via a selected user-interface, where the legacy software is used in the typical fashion and without the teachings of the present invention. However, as will be explained in greater detail below, in the present embodiment the user-interface of the legacy software application has been modified to receive data for each of the fields in Table 2 from customer 22 via vendor server 32, rather than through direct entry as found in the prior art. Those of skill in the art will now recognize that Fields 1-6 shown in Table 1 map to Fields 1-6 of Table 2, and thus the data for the legacy software application (shown as the field in Table 2) can be populated by vendor server 32 using a request from customer 22.

Vendor server 32 is also locally connected to a delivery server 52 via local area network 40. Delivery server 52, in turn, is connected to a warehouse client 56. Delivery server 52 and warehouse client 56, collectively comprise a delivery system for processing orders that have been received from customer 22, and for which orders have been successfully paid-for using payment server 36. Thus, once payment server 36 successfully processes customer 22's payment, delivery server 52 will then “approve” the order for shipping, and present the order information on warehouse client 56. The delivery information contained in Field 7 of Table 1, or the “Product” Field is thus presented on warehouse client 56. A shipping clerk using warehouse client 56 can then use the order delivery information presented on warehouse client 56 to obtain the product ordered by customer 22 and ship that item to customer 22. Once the shipping clerk has ensured the product is in stock, and has delivered the product, the shipping clerk can confirm that the product has actually been delivered by updating, (using client 56's connection to server 32) , the data contained in Field 8 shown in Table 1.

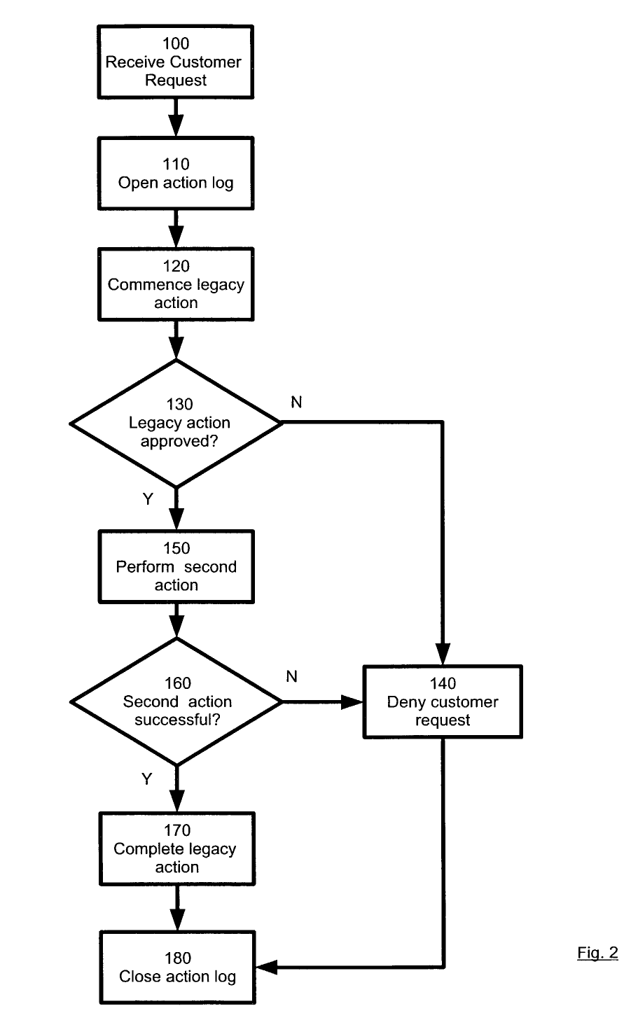

Referring now to FIG. 2, a method for interfacing with a legacy system will now be discussed. In order to assist in the explanation of the method, it will be assumed that the method in FIG. 2 is operated using system 20. Furthermore, the following discussion of the method of FIG. 2 will lead to further understanding of system 20. (However, it is to be understood that system 20 and/or the method of FIG. 2 can be varied, and need not work exactly as discussed herein in conjunction with each other, and that such variations are within the scope of the present invention.)

First, at step 100, a customer request is received. When step 100 is performed on system 20, the request is received from customer 22 who is operating client 24. This can be accomplished using a variety of means known in the art. For example, a web browser (or the like) executing on client 24 can be used by customer 22 to access network 28 and in turn access the enterprise application executing on vendor server 32. Continuing with this example, it is assumed that the enterprise application on vendor server 32 offers books for sale, and that customer 22 can select one or more of a number of books, pay for those books using the enterprise application, and have those books delivered to customer 22. Thus, when step 100 occurs on system 20, it is assumed that customer 22 has requested to purchase one of the offered books, and this request is accompanied with the payment information represented as Fields 2-5 (i.e. Customer Name, Financial Institution, Account Number, Payment Amount) in Table 1 above. The selected book, and customer 22's payment information, thus constitutes the “request” received at vendor server 32. (In general, those of skill in the art will appreciate that step 100 can occur in any variety of ways, depending on the computing system and network used to vender and delivery and receive the request, and the particular enterprise application being executed.)

The method then advances to step 110, at which point an action log record is opened. Continuing with the example using system 20, when step 110 is performed on system 20 the action log record is opened by vendor server 32, which creates an action log record that is specific to the customer request received at step 100. Such an action log record includes populating a record in a database structured with the fields shown in Table 1 (or the like). Table 3 shows an example of an action log record that can be created at step 110.

TABLE 3
Example Action Log Record created on Vendor server 32

| FIELD | | ACTION LOG |
|---|---|---|
| NUMBER | FIELD | RECORD |
| 1 | Reference | AAA |
| 2 | Customer Name | John Smith |
| 3 | Financial Institution | ACME Bank |
| 4 | Account Number | 12345 |
| 5 | Payment Amount | $35.00 |
| 6 | Payment Status | No |
| 7 | Product | Text book entitled |
| | | “How to Repair |
| | | Anything” |
| 8 | Delivery Status | No |
| 9 | Customer Address | 789 Any Street, |
| | | Anytown, USA |
| 10 | Order status | Open |

Thus, Field 1, the “Reference” field is populated with a unique identifier created by vendor server 32 which uniquely identifies the particular Order—in the present example shown in Table 3, the “Reference field” is “AAA”.

Field 2, the “Customer Name” field is populated with the name of customer 22 as provided by customer 22 at client 24—in the present example shown in Table 3, the “Customer name” is “John Smith”.

Field 3, the “Financial Institution” field is populated with the name of customer 22's financial institution as provided by customer 22 at client 24—in the present example shown in Table 3, the “Financial Institution” is the “Acme Bank”.

Field 4, the “Account Number” field is populated with the account number of customer 22's account at the Financial Institution identified in Field 3, as provided by customer 22 at client 24—in the present example shown in Table 3, the “Account Number” is “12345”.

Field 5, the “Payment Amount” field is populated by server 32 according to the price of the actual product, and any taxes, shipping fees and other relevant charges that are associated with the product that was requested by customer 22—in the present example shown in Table 3, the “Payment Amount” is “$35.00”.

Field 6, the “Payment Status” field is populated with the flag “No”, by vendor server 32, indicating that the actual financial debiting at financial institution server 48, as contemplated by the data shown in fields 3-5, has not been pre-approved, and has not yet been “completed” or actually performed at this time.

Field 7, the “Product” field is populated by server 32 according to name of the product actually requested by customer 22, the price of which corresponds to the price indicated in Field 5—in the present example shown in Table 3, the “Product” is a text book entitled “How to Repair Anything”.

Field 8, the “Delivery Status” field is populated with the flag “No”, by vendor server 32, indicating that the the product identified in Field 7 has not yet been delivered to customer 22.

Field 9, the “Customer Address” field is populated with the address of customer 22 as provided by customer 22 at client 24, and the address to which the requested product is to be delivered—in the present example shown in Table 3, the “Customer Address” is “789 Any Street, Anytown, USA”.

Field 10, the “Order Status” field is populated with the flag “Open” by vendor server 32, indicating that the the entire order with customer 22 is open and therefore on-going.

As previously mentioned, the contents of the action log are permanently stored at this point on a hard disk, and not merely left in RAM, so that the log can be recovered should system 20 fail and/or otherwise cause the interruption of the method.

The method then advances to step 120, at which point a legacy action is commenced. In a present embodiment, this step is performed by system 20, wherein server 32 passes the payment information received from customer 22 to the legacy software application executing on payment server 36, via the appropriately-modified existing interface on the legacy software application. In the foregoing example, the data within the action log of the fields of Table 3 are transferred to payment server 36 in order to populate the corresponding fields of the legacy software application, as shown in Table 4.

TABLE 4
Example of Populated Payment Information Data Fields on
Legacy Software Application on Payment Server 36

| FIELD | | PAYMENT |
|---|---|---|
| NUMBER | FIELD | INFORMATION |
| 1 | Reference | AAA |
| 2 | Customer Name | John Smith |
| 3 | Financial | ACME Bank |
| | Institution | |
| 4 | Account Number | 12345 |
| 5 | Payment Amount | $35.00 |
| 6 | Payment Status? | No |

Thus, it can be seen that the Fields 1-6 shown in Table 4 reflect the data in the action log shown in Fields 1-6 of Table 3.

Continuing now with the explanation of step 120, the legacy software application on payment server 36 then takes the information in Table 4, and accesses financial institution server 48 via network 44, in the usual manner and using the existing functionality of the legacy software application, to seek pre-approval for the debiting of customer 22's account, based on the payment information provided and reflected in Table 4.

The method then advances to step 130, at which point a determination is made as to whether the legacy action commenced at step 120 has been pre-approved. Financial institution server 48 and payment server 36 thus cooperate to determine whether pre-approval has occurred, in the usual manner using the existing functionality of the legacy software application.

If for any reason the pre-approval process fails (i.e. insufficient funds, invalid security, etc.), then the method advances from step 130 to step 140, at which point the customer request is denied, and a message indicating such denial is returned by payment server 36 to vendor server 32, which in turn passes the denial message onto customer 22 at client 24. The method then moves from step 140 to step 180, at which point the action is closed, by setting the Order Status (i.e. Field 10 of Table 3) of the action log to “Closed”. As previously mentioned, the contents of the action log are permanently stored at this point on a hard disk, and not merely left in RAM, so that the log can be recovered should system 20 fail and/or otherwise cause the interruption of the method. Should the customer wish to reattempt the purchase, then the method can begin anew at step 100.

However, at step 130, where appropriate security verifications have occurred, and sufficient funds to exist in customer 22's account, (and/or any other pre-approval criteria that is required occurs) then pre-approval will be made, and the payment status field (i.e Field 6 of Tables 3 and 4) will be set to “Pre-approved”. Further, the determination at step 130 will result in a “yes”, pre-approval has occurred, and the method will advance from step 130 to step 150. The contents of the action log are permanently stored on a hard disk, and not merely left in RAM, so that the log can be recovered should system 20 fail and/or otherwise cause the interruption of the method.

At step 150, the second action corresponding to the customer request received at step 100 occurs. When step 150 is executed on system 20, server 32 will pass the delivery information onto delivery server 52. Continuing with the example, the delivery information will include the data in action log, as shown in Fields 2,7-9 in Table 3. Thus:

1. the name of customer 22 (Field 2=“John Smith”);

2. the product name (Field 7=“Text book entitled How to Repair Anything”);

3. the delivery status (Field 8=“No”); and,

4. the address of customer 22 (Field 9=“789 Any Street, Anytown, USA”)

are all passed to delivery server 52 and presented on warehouse client 56. The shipping clerk using warehouse client 56 can then use the order information presented on warehouse client 56 to physically obtain the product ordered by customer 22 and organize the shipping of that item to customer 22 at customer 22's provided address.

The method then advances to step 160, at which point a determination is made as to whether the second action performed at step 150 was successful. If for any reason the second action was unsuccessful (for example, the product was not in stock), then the method moves from step 160 to step 140, at which point the customer request is denied, and a message indicating such denial is returned by delivery server 52 to vendor server 32, which in turn passes the denial message onto customer 22 at client 24. The method then moves from step 140 to step 180, at which point the action is closed, by setting the Order Status (Field 10 shown Table 3) in the action log to “Closed”. Should the customer wish to reattempt the purchase at a later date, or request a purchase of another product, then the method can begin anew at step 100. The contents of the changed action log are permanently stored at this point on a hard disk, and not merely left in RAM, so that the log can be recovered should system 20 fail and/or otherwise cause the interruption of the method.

If, however, at step 160 a determination is made that the second action was successful, (i.e. The product was in stock and it has been sent out for delivery), then method advances to step from step 160 to step 170.

At step 170, the legacy action is completed. When step 170 is implemented on system 20 using the example being presented herein, the shipping clerk will confirm that the product has actually been delivered by updating, (using client 56's connection to server 32 via server 52), the data contained in Field 8 shown in Table 1 to indicate a “yes” status in Field 8. The “yes” status in Field 8 is then relayed back to vendor server 32, which in turn updates Field 6 of the action log (i.e. Field 6 shown in Table 3) to the “complete” state. In turn, this instruction to complete is then relayed to the legacy software application executing on payment server 36, by updating the Field 6 of the Payment Information Data Fields on payment server 36 to “complete”, (i.e. Field 6 shown in Table 4) thereby completing the payment that was pre-approved at steps 120 and 130. Payment server 36 thus, in turn, issues a final instruction to financial institution server 48 to actually deduct the payment from customer 22's account and credit the account of the vendor operating vendor server 32. Those of skill in the art will appreciate that the actual payment process of debiting and crediting is performed using the existing functionality inherent to the legacy software application on payment server 36. The contents of the updated action log are permanently stored substantially simultaneously with the point at which the actual debiting occurs in financial institution server 48, and not merely left in RAM, so that the log can be recovered should system 20 fail and/or otherwise cause the interruption of the method. It is to be understood that various other checks can be added to ensure that the permanent writing of the action log to indicate that the payment is “complete” and can be accomplished in a variety ways. In general, the permanent storing of the action log to indicate the payment process is “complete” should occur in such a way as to accurately reflect the actual status of the payment debiting, in the event that system 20 is interrupted in its performance of step 170.

The method then advances to step 180, at which point the action log is closed, by setting the Order Status (i.e. Field 10 shown Table 3) to “Closed”. This change to the action log is permanently stored on hard disk so that, on recovery of an interruption in system 20, this change will indicate that no further action is required on this particular action. Should the customer wish to make request another purchase, then the method can begin anew at step 100.

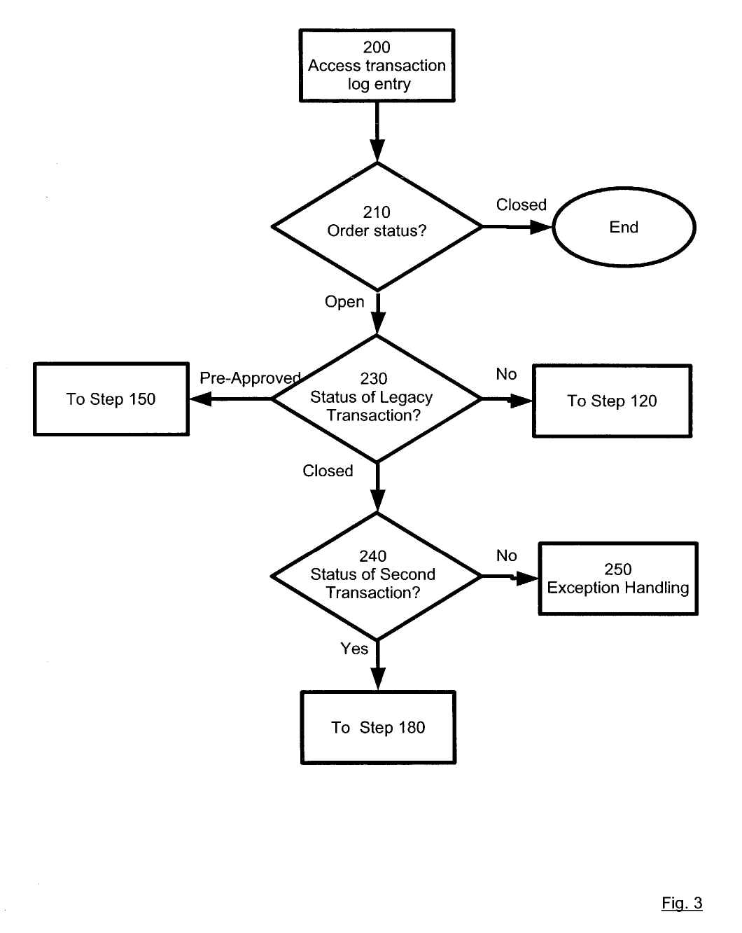

Referring now to FIG. 3, a method for initiating a system that is interfacing with a legacy system will now be discussed. In order to assist in the explanation of the method, it will be assumed that the method in FIG. 3 is operated using system 20 when server 32 is initiated or “booted up”. Furthermore, it is to be understood that system 20 (or any other system) operating the method in FIG. 3 will also be operating the method shown in FIG. 2 (or a variation thereof), as the method of FIG. 3 provides a means for recovering an interruption of the method in FIG. 2. Such interruptions could occur for any variety of reasons, including a power failures or failures of one or more network connections shown in system 20. The method in FIG. 3 utilizes the action log, in its permanently stored form, so that the method in FIG. 3 can ascertain the state of the action at the time of the interruption, and thereby recover the action and/or reconcile any inconsistent states in the action.

Beginning at step 200, when server 32 is booted up, or otherwise started or restarted at any time when it is possible that the method in FIG. 2 was previously interrupted, the action log stored on server 32 is accessed, and each record therein reviewed.

At step 210, the order status (i.e. Field 10) of a particular record in the action log is examined, and it is determined whether a particular order is “open” or “closed”. Using system 20, the action log represented in Table 1 (and by specific example in Table 3) is accessed, and Field 10 “Order Status” is examined. If it is determined at step 210 that the Order Status field shows that the particular record is “closed”, then the method shown in FIG. 3 simply ends, and the method restarts anew by examining all records until all records in the action log have been examined.

If it is determined at step 210, however, that the particular record being examined is “open”, then the method advances to step 230, where the status of the legacy action that was being conducted is examined. Using the above example, if Field 6 of Table 1 (the “Payment Status” field of the log) indicates “No”, then the method in FIG. 3 recommences the method of FIG. 2 for that particular action, but resumes the processing of the method in FIG. 2 directly at step 120, (i.e. The the above-described commencement of legacy action) thereby resuming the method in FIG. 2 where it was interrupted.

If it is determined at step 230, however, that Field 6 of Table l(the “Payment Status” field of the log) indicates “Pre-approved”, then the method in FIG. 3 recommences the method of FIG. 2 for that particular action, but resumes the processing of the method in FIG. 2 at step 150 (i.e. The performance of the second action), thereby resuming the method in FIG. 2 where it was interrupted.

If it is determined at step 230, however, that Field 6 of Table l(the “Payment Status” field of the log) indicates “complete”, (i.e. That the customer's payment was completed and that their bank account has been debited), then the method in FIG. 3 advances to step 240.

At step 240, the status of the second action is determined. Continuing with the above example, if Field 8 of Table 1 (the “Delivery Status” field of the log) indicates “Yes”, that delivery has occurred, then the method in FIG. 3 recommences the method of FIG. 2 but starts the processing of the method in FIG. 2 at step 180 (i.e. The closure of the action) thereby recommencing the method in FIG. 2 where it was interrupted.

If, however, at step 240 it is determined that Field 8 of Table 1 (the “Delivery Status” field of the log) indicates “No”, that delivery has not occurred, then the method in FIG. 3 advances to step 250.

At step 250, any suitable exception handling routine is commenced to manage the inconsistent states between the “complete” status of reflected in Field 6 of Table 1, and the “No” or non-delivery status reflected in Field 8 of Table 1. Those of skill in the art will now recognize that where these inconsistent states occur, it will be impossible or very difficult to determine at which point and how the method in FIG. 2 was interrupted, since the “complete” status in Field 6 should not have been set until the “Yes” status of Field 8 has been set. The exception handling routine, thus initiates steps to manage this exception using any desired means. For example, it could be desired to simply commence the step of delivering the requested product to customer 22. Alternatively, customer 22 could be contacted to see if the product was actually delivered. Alternatively, steps could be taken to contact customer 22's financial institution to reverse the payment debited from customer 22's account. Other exception handling routines will now occur to those of skill in the art.

It is to be understood that the various steps, tables and other features of the method FIG. 2 can be modified according to the particular legacy software application to which the method is being applied. Further, the syntax and programming structures that can be used to implement the method in FIG. 2, and variations thereof, is not particularly limited.

In particular, it is contemplated that the method in FIG. 2 can be adapted to work with legacy software that is implemented using atomic or transactional databases. As is understood by those of skill in the art, in an atomic databases, actions are typically referred to as transactions. In atomic databases, transactions are generally guaranteed to complete successfully, or not at all. A successfully completed transaction will be “committed” using a “commit” command or any other like command according to the syntax of the programming environment being used. If, however, an error prevents a partially-performed transaction from proceeding to completion, then the partially-performed transaction is “rolled-back”, using a “rollback” command or any other like command according to the syntax and functionality of the programming environment. These features are particularly useful for preventing one or more databases from being left in an inconsistent state, and can therefore offer useful functionality when applied to the present invention.

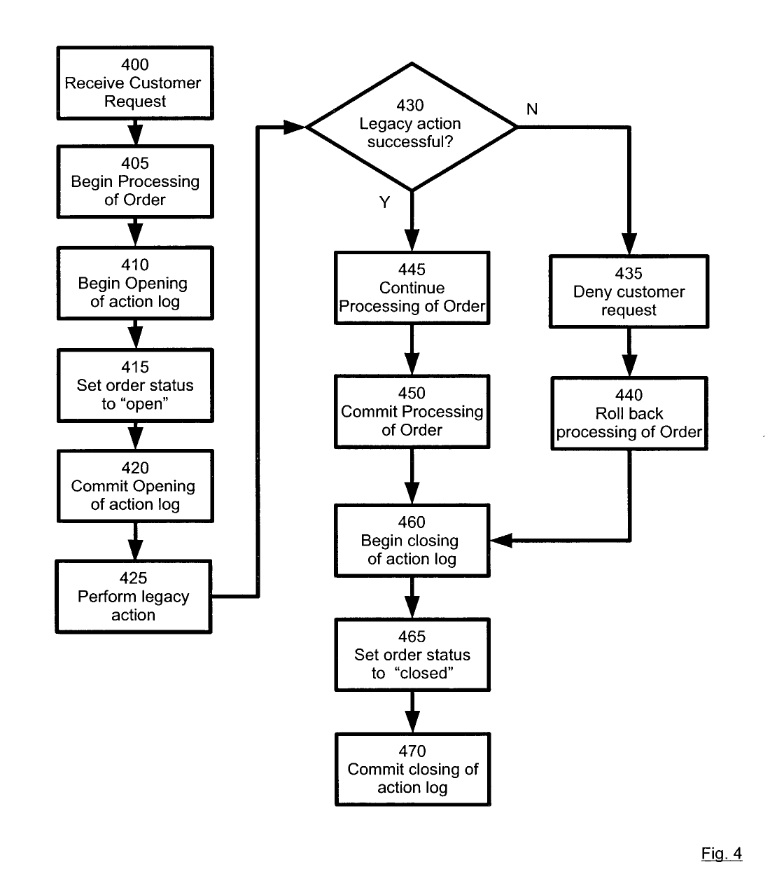

Referring now to FIG. 4, a method for interfacing with a legacy system will now be discussed. The method in FIG. 4 shows an exemplary method of interfacing with a legacy software application using an atomic database. In order to assist in the explanation of the method, it will be assumed that the method in FIG. 4 is operated using system 20. Furthermore, the following discussion of the method of FIG. 4 will lead to further understanding of system 20. (However, it is to be understood that system 20 and/or the method of FIG. 4 can be varied, and need not work exactly as discussed herein in conjunction with each other, and that such variations are within the scope of the present invention.) Furthermore, it is to be understood that the method in FIG. 4 can be the basis for interfacing with either of the legacy software applications such as Cybersource (See www.cybersource.com) or Cybercash (See www.verisign.com).

First, at step 400, a customer request is received. When step 400 is performed on system 20, the request is received from customer 22 who is operating client 24. This can be accomplished using a variety of means known in the art. For example, a web browser (or the like) executing on client 24 can be used by customer 22 to access network 28 and in turn access the enterprise application executing on vendor server 32. Continuing with this example, it is assumed that the enterprise application on vendor server 32 offers books for sale, and that customer 22 can select one or more of a number of books, pay for those books using the enterprise application, and have those books delivered to customer 22. Thus, when step 400 occurs on system 20, it is assumed that customer 22 has requested to purchase one of the offered books, and this request is accompanied with the payment information represented as Fields 2-5 (i.e. Customer Name, Financial Institution, Account Number, Payment Amount) in Table 1 above. The selected book, and customer 22's payment information, thus constitutes the “request” received at vendor server 32. (In general, those of skill in the art will appreciate that step 400 can occur in any variety of ways, depending on the computing system and network used to enter and delivery and receive the request, and the particular enterprise application being executed.)

The method then advances to step 405, at which point system 20 begins processing the order respective the customer request received at step 400. The “begin” command of an atomic database language is a suitable command for implementing step 405.

The method then advances to step 410, at which point system 20 begins opening an action log. The “begin” command, or its equivalent, of an atomic database language is a suitable command for implementing step 410.

Next at step 415 the order status an action log record is set to “Open”. Continuing with the example using system 20, when step 415 is performed on system 20 the action log record is opened by vendor server 32, which creates an action log record that is specific to the customer request received at step 100. Such an action log record includes populating a record in a database structured with the fields shown in Table 1 (or the like). Table 5 shows an example of an action log record that can be created at step 415.

TABLE 5
Example Action Log Record created on Vendor server 32

| FIELD | | ACTION LOG |
|---|---|---|
| NUMBER | FIELD | RECORD |
| 1 | Reference | AAA |
| 2 | Customer Name | John Smith |
| 3 | Financial Institution | ACME Bank |
| 4 | Account Number | 12345 |
| 5 | Payment Amount | $35.00 |
| 6 | Payment Status | No |
| 7 | Product | Text book entitled |
| | | “How to Repair |
| | | Anything” |
| 8 | Delivery Status | No |
| 9 | Customer Address | 789 Any Street, |
| | | Anytown, USA |
| 10 | Order status | Open |

Thus, Field 1, the “Reference” field is populated with a unique identifier created by vendor server 32 which uniquely identifies the particular Order—in the present example shown in Table 5, the “Reference field” is “AAA”.

Field 2, the “Customer Name“field is populated with the name of customer 22 as provided by customer 22 at client 24 and received at server 20 at step 400—in the present example shown in Table 5, the “Customer name” is “John Smith”.

Field 3, the “Financial Institution” field is populated with the name of customer 22's financial institution as provided by customer 22 at client 24 and received at server 20 at step 400—in the present example shown in Table 5, the “Financial Institution” is the “Acme Bank”.

Field 4, the “Account Number” field is populated with the account number of customer 22's account at the Financial Institution identified in Field 3, as provided by customer 22 at client 24 and received at server 20 at step 400—in the present example shown in Table 5, the “Account Number” is “12345”.

Field 5, the “Payment Amount” field is populated by server 32 according to the price of the actual product, and any taxes, shipping fees, etc. associated with the product that was requested by customer 22 and received at server 20 at step 400—in the present example shown in Table 5, the “Payment Amount” is “$35.00”.

Field 6, the “Payment Status” field is populated with the flag “No”, by vendor server 32, indicating that the actual financial debiting at financial institution server 48, as contemplated by the data shown in fields 3-5, has not been successfully completed at this time. However, as will be discussed in greater detail below, in contrast to Field 6 in Tables 1 and 3, the only two states for Field 6 in Table 5 is “No” or “Yes”.

Field 7, the “Product” field is populated by server 32 according to name of the product actually requested by customer 22 and received at server 20 at step 400, the price of which corresponds to the price indicated in Field 5—in the present example shown in Table 5, the “Product” is a text book entitled “How to Repair Anything”.

Field 8, the “Delivery Status” field is populated with the flag “No”, by vendor server 32, indicating that the the product identified in Field 7 has not yet been delivered to customer 22.

Field 9, the “Customer Address” field is populated with the address of customer 22 as provided by customer 22 at client 24 and received at server 20 at step 400, and the address to which the requested product is to be delivered—in the present example shown in Table 5, the “Customer Address” is “789 Any Street, Anytown, USA”.

Field 10, the “Order Status” field is populated with the flag “Open” by vendor server 32, indicating that the the entire order with customer 22 is open and therefore on-going.

The method then advances to step 420, at which point system 20 commits opening of an action log. The “commit” command of an atomic database language is a suitable command for implementing step 420. At this point, the contents of the action log shown in Table 5 are permanently stored at this point on a hard disk (or other persistent data storage means), and not merely left in RAM, so that the log, in its current state, can be recovered should system 20 fail and/or otherwise cause the interruption of the method.

The method then advances to step 425, at which point a legacy action is performed. In a present embodiment, this step is performed by system 20, wherein server 32 passes the payment information received from customer 22 to the legacy software application (such as Cybersource or Cybercash, or the like) executing on payment server 36, via the appropriately-modified existing interface on the legacy software application. In the foregoing example, the data within the action log of the fields of Table 3 are transferred to payment server 36 in order to populate the corresponding fields of the legacy software application, as shown in Table 6.

TABLE 6
Example of Populated Payment Information Data Fields on
Legacy Software Application on Payment Server 36

| FIELD | | PAYMENT |
|---|---|---|
| NUMBER | FIELD | INFORMATION |
| 1 | Reference | AAA |
| 2 | Customer Name | John Smith |
| 3 | Financial | ACME Bank |
| | Institution | |
| 4 | Account Number | 12345 |
| 5 | Payment Amount | $35.00 |
| 6 | Payment Status? | No |

Thus, it can be seen that the Fields 1-6 shown in Table 6 reflect the data in the action log shown in Fields 1-6 of Table 5.

Continuing now with the explanation of step 425, the legacy software application on payment server 36 then takes the information in Table 6, and accesses financial institution server 48 via network 44, in the usual manner and using the existing functionality of the legacy software application, and attempts to actually debit customer 22's account, based on the payment information provided and reflected in Table 4.

The method then advances to step 430, at which point a determination is made as to whether the legacy action commenced at step 425 was successful. Due to the inherent in the features of the legacy software application, this success or failure of the payment is inherently available for delivery to server 32. Financial institution server 48 and payment server 36 thus cooperate to deliver whether the performance of debiting the customer's account was successful, in the usual manner using the existing functionality of the legacy software application.

If for any reason the performance of the legacy action fails (i.e. insufficient funds, invalid security, etc.), then the method advances from step 430 to step 435, at which point the customer request is denied, and a message indicating such denial is returned by payment server 36 to vendor server 32, which in turn passes the denial message onto customer 22 at client 24.

The method then moves from step 435 to step 440, at which point the processing of the order is “Rolled-back”, using a “roll-back” command or the like, thereby rolling back the processing of the order to the point prior to step 405 and effectively terminating any further action being taken under that command. The method then advances from step 440 to step 460. The details of step 460 will be discussed in greater detail below.

However, if, at step 430, it is determined that the performance of the legacy transaction at step 425 was successful (i.e. appropriate security verifications have occurred, sufficient funds existed in customer 22's account, and the debiting of the customer 22's account was successful) then the payment status field (i.e Field 6 of Tables 5 and 6) will be set to “Yes” and the method will advance from step 430 to step 445. (It is to be understood that the actions of setting Field 6 of Tables 5 and 6 to the “Yes” state are typically performed between a Begin command and Commit command, similar to step 410 and 420 respectively, to ensure that this change in the action log is permanently stored on a hard disk, and not merely left in RAM, so that this status in the log can be recovered should system 20 fail and/or otherwise cause the interruption of the method.)

At step 445, the order continues to be processed based on the the customer request received at step 400. When step 445 is executed on system 20, server 32 will pass the delivery information onto delivery server 52. Continuing with the example, the delivery information will include the data in action log, as shown in Fields 2,7-9 in Table 5. Thus:

1. the name of customer 22 (Field 2=“John Smith”);

2. the product name (Field 7=“Text book entitled How to Repair Anything”);

3. the delivery status (Field 8=“No”); and,

4. the address of customer 22 (Field 9=“789 Any Street, Anytown, USA”)

are all passed to delivery server 52 and presented on warehouse client 56. The shipping clerk using warehouse client 56 can then use the order information presented on warehouse client 56 to physically obtain the product ordered by customer 22 and organize the shipping of that item to customer 22 at customer 22's provided address. (For purposes of explaining the present embodiment, it is assumed that this continued processing at step 445 is always successful, but it is to be understood that additional steps can be added to the method in FIG. 4 to handle various exceptions or failures that may occur during the processing of the order, or performance of some other type of customer request.)

The method then moves from step 450 to step 460, at which point system 20 begins closing of the action log. (It should now also be apparent that step 460 can be arrived at from step 440) . The “begin” command of an atomic database language is a suitable command for implementing step 460.

Next, at step 465 the Order Status (Field 10 shown Table 5) in the action log is set to “Closed”.

The method then advances to step 470, at which point system 20 commits closing of the action log. The “commit” command of an atomic database language is a suitable command for implementing step 470. At this point, the contents of the action log shown in Table 5 are permanently stored at this point on a hard disk (or other persistent data storage means), and not merely left in RAM, so that the log, in its current state, can be recovered should system 20 fail and/or otherwise cause the interruption of the method.

It should now be apparent that after step 470, the method ends, and that, if the customer request was denied at step 435 then customer 22 can begin the method anew at step 400 and reattempt the order. By the same token, if the order was processed at step 435, then the method can begin anew for a new order by customer 22.

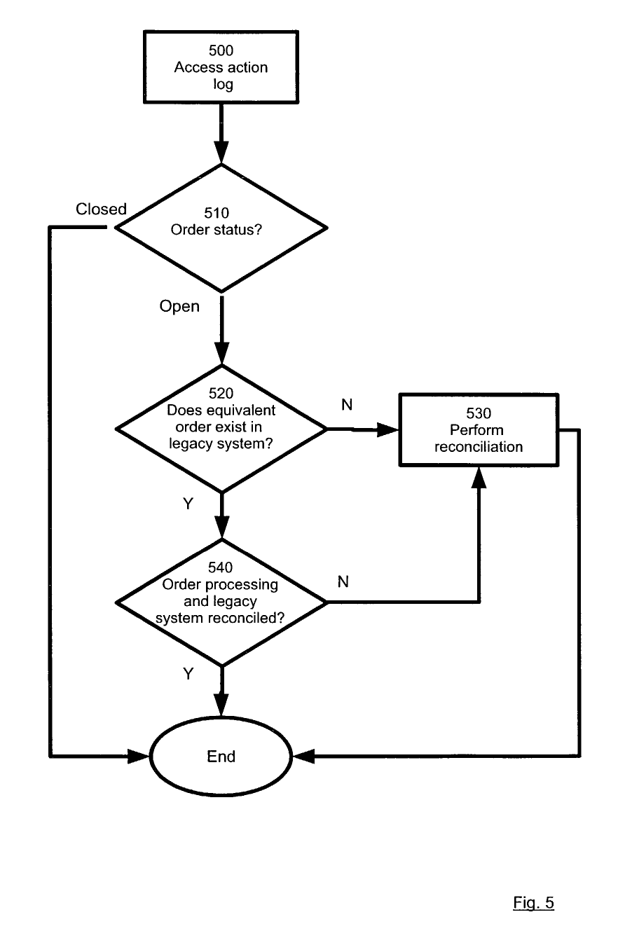

Referring now to FIG. 5, a method for initiating a system that is interfacing with a legacy system will now be discussed. In order to assist in the explanation of the method, it will be assumed that the method in FIG. 5 is operated using system 20 when server 32 is initiated or “booted up”. Furthermore, it is to be understood that system 20 (or any other system) operating the method in FIG. 5 will also be operating the method shown in FIG. 4 (or a variation thereof), as the method of FIG. 5 provides a means for recovering an interruption of the method in FIG. 4. Such interruptions could occur for any variety of reasons, including a power failures or failures of one or more network connections shown in system 20. The method in FIG. 5 utilizes the action log, in its permanently stored form, so that the method in FIG. 4 can ascertain the state of the action at the time of the interruption, and thereby recover the action and/or reconcile any inconsistent states in the action.

Beginning at step 500, when server 32 is booted up, or otherwise started or restarted at any time when it is possible that the method in FIG. 4 was previously interrupted, the action log stored on server 32 is accessed, and each record therein reviewed.

At step 510, the order status (i.e. Field 10) of a particular record in the action log is examined, and it is determined whether a particular order is “open” or “closed”. Using system 20, the action log represented in Table 1 (and by specific example in Table 5) is accessed, and Field 10 “Order Status” is examined. If it is determined at step 510 that the Order Status field shows that the particular record is “closed”, then the method shown in FIG. 5 simply ends, and the method restarts anew by examining all records until all records in the action log have been examined.

If it is determined at step 510, however, that the particular record being examined is “open”, then the method advances to step 520, where a determination is made as to whether an equivalent record exists in the legacy system executing the legacy software application. At this point a query can be made to the legacy system, using functionality inherently available to the legacy system (such as that found in Cybersource or Cybercash) to query to the legacy system to determine whether there is an an equivalent record in the legacy system, bearing the same Reference number. If no such equivalent record is found in the legacy software application, then it is determined that an equivalent record does not exist in the legacy system and the method advances to step 530, at which point a reconciliation is performed. When step 530 is reached from step 520, this reconciliation will typically involve the reprocessing of customer 22's payment using the legacy system, and appropriate decisions as to how to reprocess customer 22's payment is performed by examining Field 8 in Table 5 to determine whether the customer order has been processed (i.e. Delivered), whether Field 6 of Table 5 indicates that a payment has been made etc. By examining these fields in Table 5, an appropriate decision can be made at step 530 as to how to recommence the method in FIG. 4, or to perform individual steps therein, in order to complete the entire customer request received at step 400 and ensure a reconciliation between the debiting of the customer 22's account and the processing of customer 22's order.

If, however, it is determined at step 520 that an equivalent order does exist in the legacy system, then the method advances from step 520 to step 540 and it is determined whether the legacy software application executing on server 36 and the delivery status of the order being processed server 32 and server 52 are in a reconciled state. This step is performed by comparing the data in Tables 5 and 6, and determining whether the information therein is reconciled. Where a reconciled state exists, the method advances from step 540 to the “End” of the method. However, where a reconciled state does not exist, the method advances from step 540 back to step 530, where a reconciliation is performed. When step 530 is reached from step 540, such a reconciliation can be performed by, for example, determining whether customer 22's bank account has been debited and ensuring that the corresponding delivery was made. Other types of reconciliations can be performed at step 530 depending on the the particular inconsistency that exists.

Having performed the reconciliation at step 530, the method then ends, and can begin anew until all records in the log have been searched and appropriate reconciliations performed.

While only specific combinations of the various features and components of the present invention have been discussed herein, it will be apparent to those of skill in the art that desired subsets of the disclosed features and components and/or alternative combinations of these features and components can be utilized, as desired. For example, network 44 and network 28 of system 20 are shown separately in FIG. 1, but those of skill in the art will recognize that such networks 44 and 28 could in fact be common (e.g. The Internet).

Additionally, while system 20 is shown having only one client 24, it will be understood that system 20 typically has multiple clients 24 connected to vendor server 32. Similarly, while only one financial institution server 40 is shown, typically there are multiple financial institutions connected through their own servers 40 to server 36 via network 44.

Furthermore, the methods shown in FIGS. 2 and 3 are directed to a legacy software system that includes a “complete” feature and input as part of its user interface, as is commonly found in certain legacy software payment applications. However, where such a legacy software application system lacks a “complete” feature, and/or includes a means to reverse a debiting (i.e. Credit) of a customer's account, then the methods in FIGS. 2 and 3 could be modified to simply credit the customer's account should it be determined that the customer 22's account was debited, without ever having delivered any product to the customer.

It is to be further understood that, while system 20 and FIGS. 2 and 3 show one legacy system running a legacy software application connected to a vendor server, it is to be understood that a vendor server could actually interact with a plurality of legacy systems. For example, system 20 shows a delivery server 52 executing a customized delivery application that works in conjunction with vendor server 32, however, delivery server 52 could also be a executing a legacy delivery software application, with pre-set interface similar to the legacy Payment Information Data Fields shown in Table 2. In general, the present invention can be modified for use with any number of legacy software applications or systems all communicating through a single vendor server 32.

It should now be further apparent that the present invention is also more broadly applicable to enterprise servers and enterprise server applications beyond the e-commerce application executing on vendor server 32. For example, other enterprise server applications could include course enrollment servers that interface with legacy class room scheduling software.

Furthermore, it should now be apparent that while FIG. 1 shows a separate vendor server 32, payment server 36, and delivery server 52, it should be understood that all of the applications executing thereon could be locally executed at a single server, or the functionality thereof could be distributed between a fewer or greater number of servers.

Furthermore, it is particularly contemplated in respect to system 20 in FIG. 1 that the functionality of vendor server 32 and payment server 52 can be incorporated into a single enterprise application executing on a single vendor server, and that the single enterprise application would then interface to a single payment server 36 executing the legacy payment software.

Those of skill in the art will now further recognize that the fields in the various tables described in the above embodiments contain exemplary data fields, and can include such other fields as can be desired to provided desired functionality. For example, it can be desired to include fields which can accommodate currency conversion, or to contain flags or other indicators to differentiate between the type of customer account, such as differentiating between credit cards or debit cards.

It is also contemplated that the Order Status Field (Field 10 of Table 1 and its equivalents) can be eliminated in favour of simply inferring that a particular order is “Open” by the mere existence of the action log record, and by allowing an inference of a “Closed” status by deleting the action log record once the particular action has been completed—thus, when a system is being recovered, the mere existence of the action log record will allow an inference that the unreconciled states may exist.

It is also to be understood that the various process steps that are discussed in the method embodiments herein need not be performed in the exact order as shown, and that certain steps may occur substantially simultaneously, while other steps may not. For example, it is contemplated that the payment approval steps (e.g. Steps 110 to Steps 130 of FIG. 2) can occur substantially at the same time, while the delivery steps (Step 150 of FIG. 2) can occur much later. In this particular event, the delivery steps may be performed in batches, as a plurality of approved deliveries may be processed only once or twice a day. Furthermore, it is contemplated that, in the method shown in FIG. 4, steps 425 and 445 can be performed together, prior performing step 430. Other variations in the methods discussed herein will now be apparent to those of skill in the art.

The above-described embodiments of the invention are intended to be examples of the present invention and alterations and modifications may be effected thereto, by those of skill in the art, without departing from the scope of the invention which is defined solely by the claims appended hereto.

We claim:

1. A system for interfacing with at least one legacy system, comprising: at least one host server for connection to a client, said host server for executing a software interface for receiving a client request and delivering responses to said client;
said at least one host server additionally for executing a legacy software application having a predefined set of user inputs and for performing a first task based on said inputs, said software interface being customized to provide at least a portion of said inputs to said legacy software application based on information derived from said client request; and,
said at least one host server additionally for executing an additional software application for performing a second task based on information derived from said client request and in cooperation with the performance of said first task,
said at least one host server additionally keeping a action record respective to said client request, said action log for reconciling the performance of said tasks upon an initialization of said at least one host server if said tasks are interrupted prior to a desired completion of said tasks.

2. The system according to claim 1 wherein said host server is a vendor server, said legacy software application is a legacy on-line payment software application and said first task is the processing of an on-line payment.

3. The system according to claim 2 wherein said additional software application is a delivery system and said second task is a delivery of a requested product to a customer using said client and said cooperation is an operation based on determining whether said on-line payment can be successfully processed prior to managing said delivery.

4. The system according to claim 3 wherein said delivery is preformed by an on-line download of software to said client.

5. The system according to claim 3 wherein when said system is reinitialized and said action log indicates that said payment has been processed but said product has not been delivered, then said legacy software application is instructed to reverse said on-line payment.

6. The system according to claim 3 wherein when said system is reinitialized and said action log indicates that said payment has been pre-approved but said product has not been delivered, then said second software application is instructed to commence said delivery.

7. The system according to claim 1 wherein said additional software application is a second legacy software application having a predefined second set of user inputs and for performing said second task based on information derived at least in part from said second set inputs and in cooperation with said first task.

8. The system according to claim 1 wherein said legacy software application is a user authentication system.

9. The system according to claim 1 wherein said at least one host server includes a first server, a second server and a third server interconnected by a local area network, and wherein said software interface, said legacy software application and said additional software application are executed on each of said servers respectively.

10. A method of interfacing with a legacy software application comprising the steps of:
receiving a user request;
opening a action record specific to said user request, said action record containing information for recovering a performance of said user request upon an interruption thereof;
commencing a legacy action based on information derived from said user request, said legacy action being preformed by a legacy software application;
performing a second action based on information derived from said user request and a successful commencement of said legacy action;
completing said legacy action if said second action is successful;
closing said action log upon a failure of said commencement of said legacy action or a successful performance of said second action; and,
presenting an output to said user conveying information of said failure or said success.

11. The method according to claim 10 wherein said user request is a request from a customer for a product and includes payment information, said legacy action an on-line payment performed by a legacy software application, and said commencement includes obtaining approval of said payment.

12. The method according to claim 11 wherein said second action is a delivery of a requested product to said customer upon a successful approval of said payment.

13. The method according to claim 12 wherein said delivery is performed by an on-line download of software to said client.

14. The method according to claim 11 wherein said approval is a preapproval and said completing step is an instruction to said legacy software application to debit said customer's account.

15. The method according to claim 11 wherein said approval is an actual debiting of said customer's account said completing step is either:
an update of said action log to validate said debiting on successful performance of said second action; or,
an instruction to said said legacy software application to reverse said debiting on an unsuccessful performance of said second action.

16. The method according to claim 10 wherein said second action is a second legacy action.

17. The method according to claim 10 wherein said legacy software application is a user authentication system.

18. A method of recovering a set of actions wherein at least one of said actions includes a task performed by a legacy software application comprising the steps of:
receiving a record in a log generated during an initial attempt to perform said actions, said log representing the status of performance of said actions; and,
determining, based on said record, whether one of said actions was performed when a second one of said actions should also having been performed and said second one of said actions not having been performed; and,
either recommencing performance of one or more of said actions so as to reconcile said actions or generating an exception report usable to reconcile said actions.

19. The method according to claim 18 wherein one of said actions includes an on-line payment performed by said legacy software application.

20. The method according to claim 19 wherein a second one of said actions includes delivery software for delivering a requested product to a customer based on a successful completion of an on-line payment, and said reconciliation includes ensuring that said product was delivered if said on-line payment was successfully performed.
